(19) United States
(12) Patent Application Publication
(10) Pub. No.: US 2007/0216152 A1
(43) Pub. Date: Sep. 20, 2007

(54) FIREPROOF ALBUM FOR VALUABLES

(76) Inventor: William A. Wunder, Hamilton, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/684,963

(22) Filed: Mar. 12, 2007

Related U.S. Application Data
(60) Provisional application No. 60/782,238, filed on Mar. 14, 2006.

(51) Int. Cl. B42D 1/00

(52) U.S. Cl. 281/15.1

(57) ABSTRACT

A fireproof album for storing valuable items such as photographs, coins, stamps, and the like includes a fireproof shell defining a cavity. A plurality of releasable connectors retain photos, collectible items or other valuables in the cavity. The shell may include three rigid fireproof shell components that are pivotably interconnected by a pair of hinges to provide ready access to the items stored in the photo album.

### CROSS-REFERENCE TO RELATED APPLICATIONS

This application claims the benefit of U.S. Provisional Patent Application No. 60/782,238, filed on Mar. 14, 2006, the entire contents of which are incorporated herein by reference.

### BACKGROUND OF THE INVENTION

Various types of fireproof safes and the like have been developed. Although known safes are suitable for storing jewelry, documents, and other such items, to date, a convenient way to store photographs and other such valuable items has not been developed.

### SUMMARY OF THE INVENTION

One aspect of the present invention is a fire-resistant album for storing valuables and the like. The album includes a fireproof shell having first and second primary shell members made of a substantially fireproof material. The first and second primary shell members each define a generally linear hinge edge, and the fireproof shell further includes an elongated central member made of a substantially fireproof material. The elongated central member has opposed edges hingedly connected to the hinge edges of the first and second primary shell members such that the first and second primary shell members pivot relative to the elongated central member between an opened position and a closed position relative to the elongated central member. The first and second primary shell members and the elongated central member together define a cavity when the first and second primary shell members are in the closed position. The first and second primary shell members defined first and second elongated edge surface portions, respectively, that sealingly engage one another when the first and second primary shell members are in the closed position. The first elongated edge surface portion comprises an elongated groove, and the second elongated edge surface portion comprises an elongated lip that is received in the elongated groove. The fire-resistant album further includes a plurality of ring binders secured to the elongated central member to thereby support a plurality of thin sheet-like holders of the type having pockets that receive valuable items.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is an isometric view of a fireproof album for valuables according to one aspect of the present invention;

FIG. 2 is an isometric view of the fireproof album in an opened position;

FIG. 3 is an exploded isometric view of the storage album; and

FIG. 4 is an isometric view of the storage album with a plurality of holders configured to support and retain photographs, coins, stamps, and the like.

### DETAILED DESCRIPTION OF PREFERRED EMBODIMENT

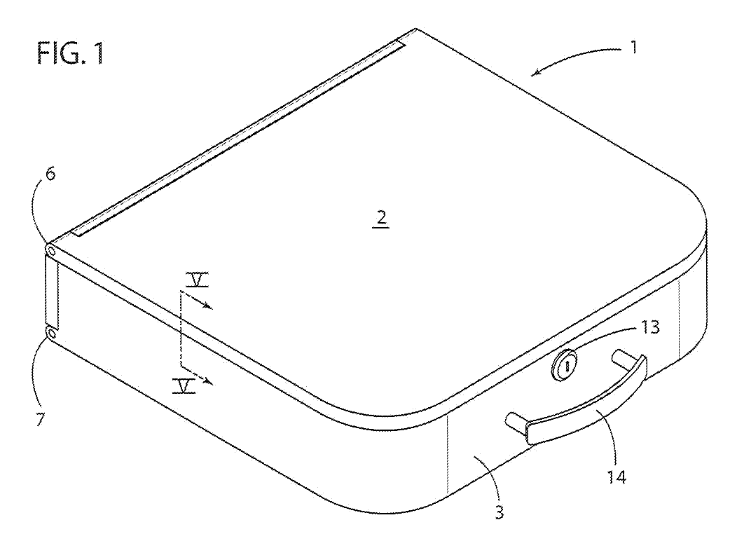

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiment disclosed herein are not to be considered as limiting, unless the claims expressly state otherwise.

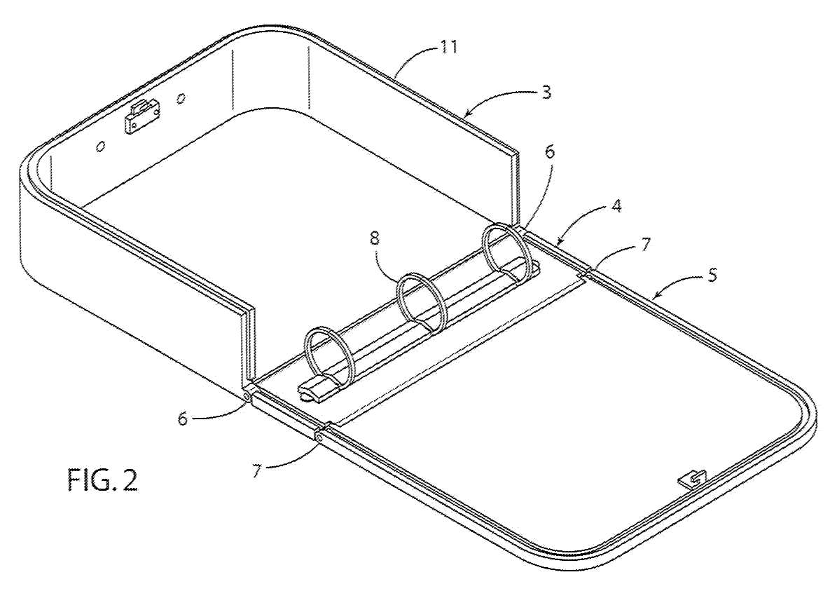

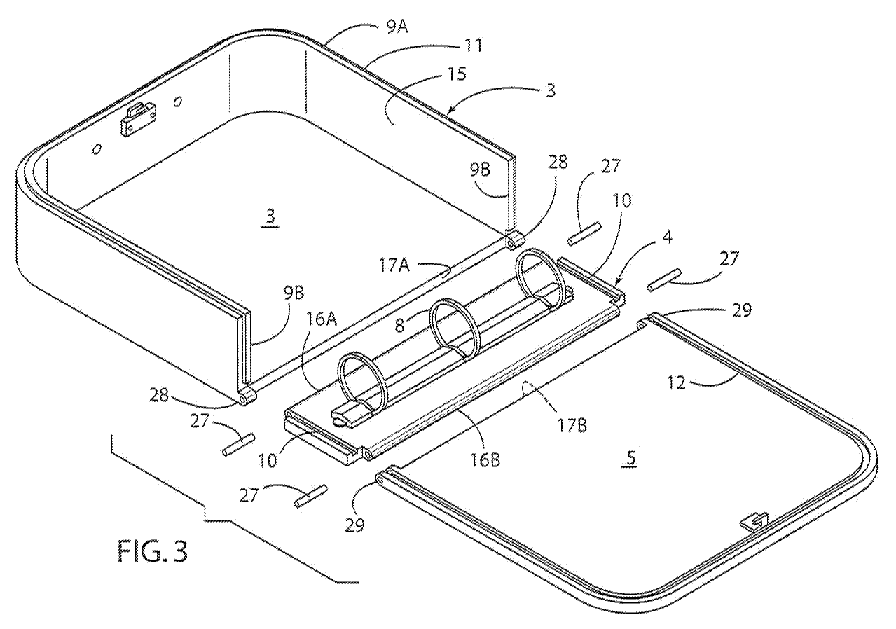

A fireproof photo album 1 (FIG. 1) according to one aspect of the present invention includes a case 2 that comprises a first primary member 3 (see also FIGS. 2 and 3), a center member 4, and a cover member 5. The first primary member 3, center member part 4, and cover member 5 are made of aluminum or other fireproof material. In a preferred embodiment, the parts are made of a heat and fire-resistant polymer material that can be formed utilizing an injection molding process. Suitable high temperature polymer materials and processes for forming these types of components are known, and will not therefore be described herein. The center part 4 is pivotally connected to the main member 3 by a hinge 6, and cover 5 is pivotally connected to the center part 4 by a hinge 7. Hinges 6 and 7 are formed by a plurality of pins 27 that are received in openings 28 and 29 of parts 3 and 5, respectively. It will be understood that a variety of hinge arrangements may be utilized. In the illustrated example, opposite side edges 16A and 16B of center part 4 are radiused to fit tightly against edge surfaces 17A and 17B of parts 3 and 5. The close fit between edges 16A and 16B and edge surfaces 17A and 17B, respectively, substantially prevents entry of fire, hot gases, or the like in the event the album 1 is exposed to a fire.

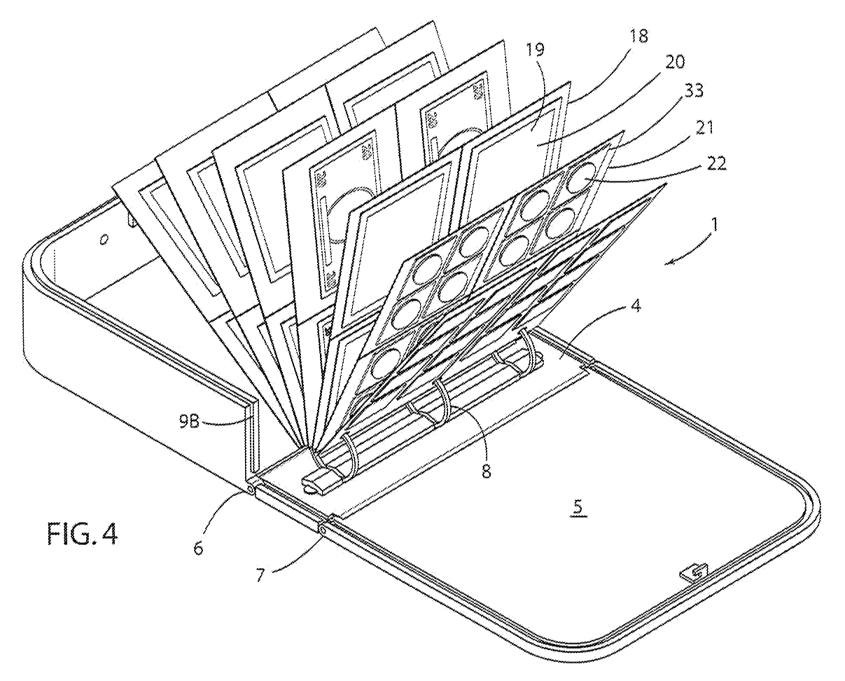

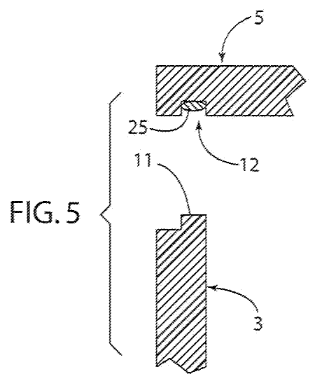

A retainer such as a ring binder 8 is secured to the center part 4. As shown in FIG. 4, ring binder 8 can retain conventional sheet-like photo holders 18 having pockets 19 that retain photos 20. Pockets 19 are preferably formed of a transparent material to enable viewing of the photos 20 or the like. Also, holders 21 for coins, baseball cards (not shown), or other collectible and/or valuable items may also be utilized. Holders 21 include a plurality of small pockets 23 forming rows. Pockets 23 are preferably made of a transparent material.

Main member 3 includes a lip 11 having a first portion 9A that is received in slot 10 of central member 4, and a second portion 9B that is received in slot 12 of cover member 5 when the album 1 is closed (FIG. 1). Lip 11 and slots 10 and 12 interlock and seal the main member 3, center part 4, and cover member 5 to thereby prevent entry of flames, hot gases, and the like. With further reference to FIG. 5, an elongated strip of resilient material 25 may optionally be positioned in groove 12. Resilient material 25 is a heat and fire-resistant material that further ensures that lip 11 seals in slot 12 to prevent entry of fire, hot gases, and the like into the album 1. It will be understood that various edge sealing arrangements may be utilized without departing from the present invention.

With further reference to FIG. 4, the fireproof photo album 1 also includes a lock 13 to prevent theft of the contents, and to ensure that the photo album 1 remains closed in the event of a fire. Also, handle 14 facilitates transport of the fireproof photo album 1.

In the foregoing description, it will be readily appreciated by those skilled in the art that modifications may be made to the invention without departing for the concepts disclosed herein. Such modifications are to be considered as included in the following claims, unless these claims by their language expressly state otherwise.

The invention claimed is:

1. A fire-resistant album for storing valuables, comprising:
a fireproof shell having first and second primary shell members made of a substantially fireproof material, the first and second primary shell members each defining a generally linear hinge edge, the fireproof shell further including as elongated central member made of a substantially fireproof material having opposed edges hingedly connected to the hinge edges of the first and second primary shell members such that the first and second primary shell members pivot relative to the elongated central member between an open position an a closed position relative to the elongated central member, the first and second primary shell members and the elongated central member together defining a cavity when the first and second primary shell members are in the closed position;
wherein the first and second primary shell members defined first and second elongated edge surface portions, respectively, that sealingly engage one another when the first and second primary shell members are in the closed position;
wherein the first elongated edge surface portion comprises an elongated groove, and the second elongated edge surface portion comprises an elongated groove, and the second elongated edge surface portion comprises an elongated lip that is received in the elongated groove;
a plurality of ring binders secured to the elongated central member to thereby support a plurality of thin sheet-like holders of the type having pockets that receive valuable items.

2. The fire-resistant album of claim 1, wherein:
the first and second primary shell members each include a generally planar central sidewall portion.

3. The fire-resistant album of claim 2, wherein:
the planar central sidewall portions of the first and second primary shell members are approximately parallel to one another when the first and second primary structural members are in the closed position.

4. The fire-resistant album of claim 3, wherein:
the first and second primary shell members each have a generally quadrilateral peripheral edge.

5. The fire-resistant album of claim 4, wherein:
at least one of the first and second primary shell members includes a peripheral sidewall extending around at least a portion of the peripheral edge, wherein the sidewall extends transverse relative to the planar central sidewall portion.

6. The fire-resistant album of claim 5, wherein:
the peripheral edges of the first and second primary shell members defined first, second, and third generally linear edge portions, and wherein the first and second linear edge portions extend orthogonally from the hinge edges, and the third edge linear edge portion extends between the first and second linear edge portions parallel to the hinge edges, and wherein the peripheral sidewall extends along the first, second, and third linear edge portions.

7. The fire-resistant album of claim 6, wherein:
the elongated lip is formed on a peripheral edge of the sidewall, and the groove is formed in an inner side surface of the other of the first and second primary shell members.

8. The fire-resistant album of claim 7, wherein:
the sidewall includes an end edge that engages the elongated central member when the one primary shell member is in the closed position relative to the elongated central member, wherein the end edge includes a lip;
the elongated central member defined opposite end edges extending between the opposed edges, and wherein the elongated central member includes a groove that receives the lip on the end edge.

9. The fire-resistant album of claim 8, wherein:
the lip on the end edge of the sidewall is continuously formed with the elongated lip on the edge of the sidewall.

10. The fire-resistant album of claim 9, wherein:
the end edge of the sidewall is orthogonal to the peripheral edge of the sidewall.

11. The fire-resistant album of claim 1, wherein:
the first and second shell members and the elongated central member are made of substantially the same material.

12. The fire-resistant album of claim 11, wherein:
the first and second shell members and the elongated central member are made of metal.

13. The fire-resistant album of claim 12, wherein:
the first and second shell members and the elongated central member are made of an injection-moldable non-metallic material.

14. The fire-resistant album of claim 1, including:
a plurality of sheet-like holders having openings along a side edge that receive portions of the ring binders, the sheet-like holders having pockets therein configured to receive and support valuable items therein.

15. The fire-resistant album of claim 14, wherein:
at least one of the sheet-like holders includes a plurality of pockets forming rows, wherein the pockets are configured to retain coins.
